(19) United States
(12) Patent Application Publication
(10) Pub. No.: US 2020/0167506 A1
(43) Pub. Date: May 28, 2020

(54) Security Architecture for Partial Reconfiguration of a Configurable Integrated Circuit Die

(71) Applicant: Intel Corporation, Santa Clara, CA (US)

(72) Inventors: Prakash Iyer, Portland, OR (US); Eric Innis, Hillsboro, OR (US); Evan Custodio, North Attleborough, MA (US); Ting Lu, Austin, TX (US)

(73) Assignee: Intel Corporation, Santa Clara, CA (US)

(21) Appl. No.: 16/586,131

(22) Filed: Sep. 27, 2019

(51) Int. Cl. G06F 21/76

(52) U.S. Cl. CPC G06F 21/76; G06F 2221/2149

(57) ABSTRACT

A PCIe card includes an FPGA and a memory that is discrete from the FPGA. The memory is accessible by the FPGA and not other devices on the card. The FPGA's core fabric is configured with a security processor that verifies a bitstream loaded through the FGPA into the memory as authentic or not authentic to limit unauthorized access to data from a user circuit that is associated with a not authentic bitstream. The security processor is loaded into the FPGA when a request is made for bitstream verification and is allowed to be overwritten after the security processor processes the bitstream to determine if the bitstream is authentication or not authentic. Allowing the security processor to be overwritten allows for high percentage usage of the core fabric for user circuits and limits the inclusion of a static circuit in the core fabric that is infrequently used.

### FIELD OF THE DISCLOSURE

The present disclosure relates to a bitstream security circuit for a configurable integrated circuit die. More specifically, the present disclosure relates to a managed security accelerator circuit configured in the core fabric of a configurable integrated circuit die for authenticating a bitstream introduced into the die for partial reconfiguration of the core fabric.

### Background of the Invention

Configurable integrated circuit dies are configurable to implement a variety of circuit devices. Configurable integrated circuit dies may be configured in the field, such as in a data center, to implement various circuit devices. Different users typically want a data center to provide functions for the users' specific purposes. Thus, the users provide bitstreams for configuring configurable integrated circuit dies so that the dies implement the functions desired by the users. To provide enhanced security of such dies by inhibiting unauthorized access, a bitstream received by a die may be verified as being transmitted from a trusted source. Without such verification, a configurable integrated circuit die may be susceptible to data theft or other tampering. Bitstream authentication is typically facilitated by enhanced cryptographic functions or hash function. Security processors that perform cryptographic functions or hash functions and that are configured into the static region of the core fabric of a configurable integrated circuit die are relatively large. Keeping such large security processors in the static region of the core fabric renders the core fabric unavailable for users' circuits.

Thus, an impetus exists to provide security processors when the security processors are used for authenticating a bitstream, but otherwise make the space used by the security processors available for user circuits when bitstream authentication is not performed.

### BRIEF DESCRIPTION OF THE DRAWINGS

FIG. 1 illustrates a host that includes a configurable IC die, such as an FPGA, in an embodiment.

FIG. 2 is a flow diagram of a method for authenticating a user bitstream, in an embodiment.

FIG. 3 illustrates a host that includes a configurable IC die, such as an FPGA, in an embodiment.

FIG. 4 is a flow diagram of a method for authenticating a user bitstream, in an embodiment.

FIG. 5 is a flow diagram of a method for authenticating a bitstream, in an embodiment.

FIG. 6 illustrates a data system, in an embodiment.

FIG. 7 illustrates a data system, in an embodiment.

### DETAILED DESCRIPTION

Configurable integrated circuit (IC) dies that are often packaged discretely and as system-in-package (SiP) devices continue to fuel development in IC markets. Circuit emulation markets, ASIC prototyping markets, and data center markets are a few of the developing IC markets fueled by configurable IC dies. Configurable IC dies directed toward circuit emulation markets often include several configurable IC dies packaged as a SiP to facilitate an almost unlimited number of emulated circuits where a single configurable IC die may be unable to supply sufficient programmable fabric for implementing an emulation circuit. Configurable IC dies directed toward ASIC prototyping markets often include a number of configurable ICs dies packaged as a SiP to implement a variety of ASICs. Configurable IC dies directed toward data center markets are often discretely packaged or packaged as SiPs to facilitate ASIC functions in the data center, acceleration in the data center, to add processing capability, to add network and virtual network capability, to add non-volatile memory express capability, or other capabilities.

Configurable IC dies directed toward these markets and other markets may include field programmable gate arrays (FPGAs), programmable logic devices (PLDs), complex programmable logic devices (CPLDs), programmable logic arrays (PLAs), configurable logic arrays (CLAs), memory, transfer dies, and other ICs. Configurable IC dies typically include a number of configurable logic blocks that may be configured to implement various circuits. The logic blocks are interconnected by configurable interconnect structures that may be configured to interconnect the logic blocks in almost any desired configuration to provide almost any desired circuit.

Programmable acceleration cards, such as peripheral component interconnect express (PCIe) programmable acceleration cards, have been in the industry for some time and are often used in data centers to add processing capability to the data centers. Programmable acceleration cards in data centers offer processing power that is reconfigurable to meet a variety of processing demands of a variety of users.

Data center providers and data center users would like their data and intellectual property (IP) blocks secured so that the data and IP blocks cannot be accessed by unauthorized users. To meet the security demands of data center providers and user, programmable acceleration cards may adhere to the enhanced security standards. The security demands of data center providers and user include bitstream integrity, bitstream authentication, encryption to protect IP blocks, or any combination of these security techniques to provide that bitstreams loaded onto a configurable IC die come from a trusted source.

The core fabric of a configurable IC die included in a programmable acceleration card is often partitioned into a static region and a partial region. A static region is typically controlled by a data center provider or a configurable IC die manufacturer and is generally not accessible by other users, such as customer users. A partial region is accessible and controllable by a user via user circuits. This architecture is sometimes referred to as a shell architecture.

To provide users with maximum use of the partial region of the core fabric of a configurable IC die core, the static region of the core fabric may be lightly used. However, to perform authentication or encryption on configurable IC die bitstreams, the static region of the core fabric may be configured with one or more security processors (i.e., enhanced cryptographic circuits) that provide cryptographic functionality, hash functionality, or both that facilitate security assurances. The security processors may be considered too large to keep in the static region of the core fabric of a configurable IC die in view of the relatively seldom use of such circuits, such as during an initial bitstream load.

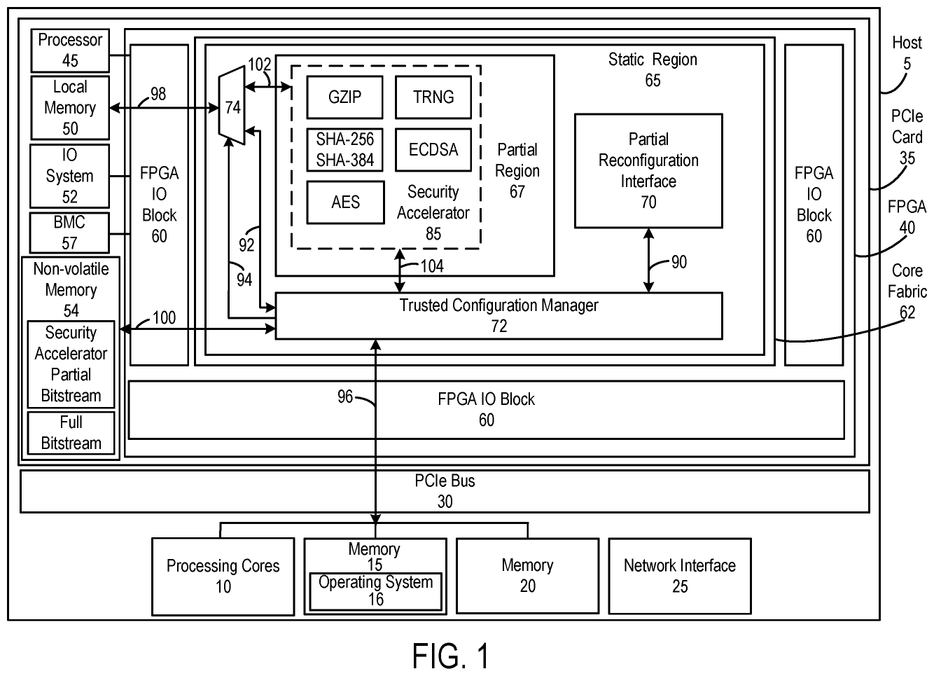

FIG. 1 illustrates a host 5 that includes a configurable IC die 40, such as an FPGA, in an embodiment. Host 5 may include one or more processor cores 10, memory 15, memory 20, a network interface controller (NIC) 25, a bus system 30, such as a PCIe bus, a PCIe card slot, and PCIe circuitry that supports the PCIe bus, and other components. The one or more processor cores may include a central processing unit (CPU), a microprocessor, a graphical processing unit (GPU), a digital signal processor (DSP), an application specific integrated circuit (ASIC), a vision processing unit (VPU), an image array processors (SIMD), a neural network processor, an artificial intelligence processor, a cryptographic accelerator, just to name a few.

Memory 15 may store a host operating system 16, other host system software, or both. Memories 15 and 20 may include one or more types of memories, such as RAM, FLASH, disk memory (e.g., magnetic memory, optical memory, or others), other types of memory, or any combination so these memory types.

Host 5 may be an aggregated server or a disaggregated server. An aggregated server may be in a single housing, on a single sled of a rack (e.g., in a data center), on a single plug-in card (e.g., a single PCIe card), on a single motherboard, or other aggregated configuration. A disaggregated server may include distributed components, such as components that are distributed on one or more circuit boards in a housing, one or more sleds in a rack, one or more sleds in different racks, on different plug-in cards, in different data centers, or may have other distributions of components. Therefore, while FIG. 1 generally shows that host 5 is an aggregated device, the illustration of the host in FIG. 1 represents a specific embodiment.

Configurable IC die 40 may be mounted on a card 35, such as a PCIe card. Card 35 may be inserted in a card slot (e.g., PCIe edge connector) on one of the circuit boards of the host, such as a PCIe card slot. The card may include a processor 45, a local memory 50 (e.g., a DDR RAM memory), an input-output (IO) system 52, a non-volatile memory 54, a baseboard management controller (BMC) 57, other components, or any combination of these components. Processor 45 may include a CPU, a microprocessor, a GPU, a DSP, an ASIC, a VPU, a SIMD, a neural network processor, an artificial intelligence processor, a cryptographic accelerator, other processors, or any combination of these processors.

In an embodiment, the processor 45 of the PCIe card operates the BMC functions of the card and the BMC is not a control circuit that is separate from the processor. In an embodiment, the BMC is a circuit on the PCIe card that is separate from the processor.

In an embodiment, the configurable IC die includes one or more IO blocks 60, a core fabric 62, and other components. IO block 60 may be connected to the PCIe bus 30 of the host and may connect the core fabric to the host. The IO block may be connected to one or more of the components mounted on card 35, such as processor 45, local memory 50, IO system 52, non-volatile memory 54, and BMC 57. The IO block may connect the core fabric to the processor, local memory, IO system, non-volatile memory, and BMC.

In an embodiment, the core fabric includes a static region 65 and a partial region 67. The partial region is shown as a region inside the static region in a shell architecture where the partial region is sometimes referred to as an inner shell and the static region is sometimes referred to as an outer shell. It will be understood, however, that the physical distribution of the static and partial regions may not be physically nested in the core fabric with the partial region in the static region.

The static region is a portion of the core fabric that includes design logic (circuits configured in the core fabric) that is typically not changed. The static region includes the portion of the design logic that does not change persona when other portions of the core fabric are configured with user circuits. This static region may include hard circuits in the periphery of the configurable IC die and circuits in the core fabric.

The partial region is a region of the core fabric that is typically available for design logic (e.g., user circuits) of users of the configurable IC die. For example, the users may be users of a data center that includes the described configurable IC die. The users may be computer systems that access the configurable IC die through the network interface card of the host via a network. User configured circuits in the core fabric may include various circuit devices, such as ASICs, digital signal processor (DSP), accelerator circuits, and numerous other devices. Embodiments described provide for allocating a portion of the core fabric (logic elements (LEs), ALMs (adaptive logic modules), RAM, digital signal processors, and other core resources) to the partial region for use by users after the portion of the partial region is used by the static region. The portion of the partial region may be viewed as being time multiplexed for use by the static region and thereafter for use by users after the static region is finished using the portion of the partial region. This shared use of the partial region is described further below.

In an embodiment, the static region includes a partial reconfiguration interface circuit 70, a trusted configuration manager circuit 72, and a multiplexer 74. The partial reconfiguration interface, the trusted configuration manager, and the multiplexer may be configured into the static region of the core fabric by configuring lookup tables in the static region of the core fabric. Lookup table configuration is well understood and is not described further.

The trusted configuration manager may be connected to the partial reconfiguration interface by a communication link 90. The trusted configuration manager may be connected to the multiplexer by a first communication link 92 (e.g., a data communication link) and a second communication link 94 (e.g., a control signal communication link). The trusted configuration manager may be connected to the host architecture by a communication link 96 that passes through the 10 block and by the PCIe bus. The communication links may include routing channels in the core fabric of the configurable IC die where various routing channels may be connected by switch blocks in the core fabric to form the communication links. The routing channels and switch blocks of a configurable IC die are well understood and are not described.

The trusted configuration manager may be connected to the local memory via a communication link 98, which extends from the multiplexer and through IO block to the local memory. In an embodiment, the configurable IC die has exclusive direct access to the local memory. That is, other circuits of the PCIe board and host may not have direct access to the local memory. The trusted configuration manager may also be connected to the non-volatile memory via a communication link 100, which extends through the IO block to the non-volatile memory.

The partial region may include a security accelerator 85. The security accelerator may be configured into the partial region when the security accelerator is to be used and may be overwritten after the security accelerator is used. The security accelerator region may be overwritten by one or more user circuit after the security accelerator is used. BMC 57 of the PCIe card, a BMC of the configurable IC die (hardwired BMC or a BMC configured in the core fabric), the trusted configuration manager, another management controller, or any combination of these circuits may control when (e.g., after use) the security accelerator may be overwritten.

The security accelerator may include one or more security processors (e.g., security circuits) that are adapted to perform various security functions. The security processors may include a SHA-256 processor, a SHA-384 processor, an ECDSA processor (elliptic curve digital signature algorithm processor), an AES processor (advanced encryption standard processor), a GZIP processor, a TRNG processor (true random number generator processor), other security processors, or any combination of these security processors. In an embodiment, the security accelerator includes a SHA-256 processor and an ECDSA processor.

The partial region may also include one or more user circuits where the users are users of the host and the configurable IC die. The users may be client computer systems that access the host via network interface 25.

The security accelerator is connected to the multiplexer by a communication link 102. The trusted configuration manager is connected by one or more communication links 104 to the security accelerator. Specifically, the trusted configuration manager is connected by one or more communication links to one or more of the security processors of the security accelerator.

In an embodiment, the security processors of the security accelerator provide security services when the host loads a user bitstream into the configurable IC die. The user bitstream may be for a user circuit where the destination of the user bitstream is the partial reconfiguration interface. The user bitstream may then be used to configure the partial region. If the bitstream is not from a trusted source user, user data and user circuits, host data and host circuits, manufacturer data and manufacturer circuits in the core fabric may be accessed by an unauthorized user. That is, an unauthorized user bitstream may be configured by a nefarious user to access, corrupt, or steal data, access, corrupt, or steal circuit configurations, or any combination of these. Therefore, the described circuits may verify the authenticity of the bitstream and verify that the bitstream has not been tampered with for such nefarious proposes.

To securely process the bitstream, the trusted configuration manager operates as a gatekeeper for the bitstream. The trusted configuration manager may reject the bitstream if the bitstream is not authenticated (e.g., does not come from a trusted source, is tampered with, or both) or may allow the bitstream to be transferred to the partial reconfiguration interface if the bitstream is authenticated (e.g., does come from a trusted source and is not tampered with). The trusted configuration manager may be a lightweight control-based manager that does not perform data processing on a bitstream but controls the security accelerator to perform data processing on a bitstream for bitstream authentication. Because the trusted configuration manager may be a lightweight control-based manager that does not perform data processing on a bitstream, the manager does not take up a large portion of the core fabric. Thus, a relatively large portion of the core fabric remains available for user circuits. The following describes a method for authenticating a bitstream in an embodiment.

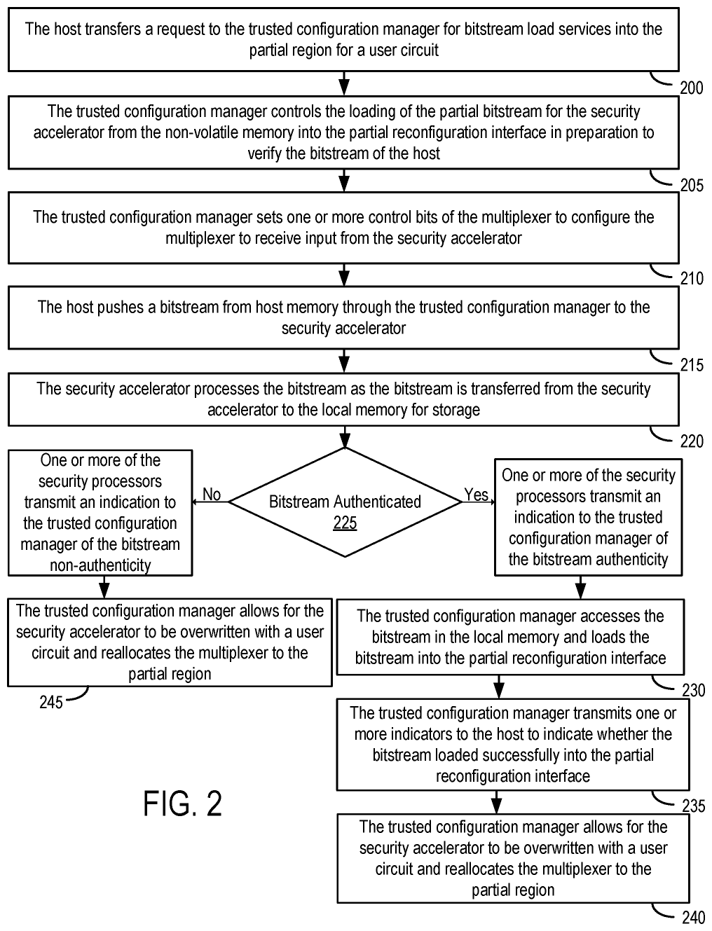

FIG. 2 is a flow diagram of a method for authenticating a bitstream, in an embodiment. The flow diagram represents one example embodiment. Steps may be added to, removed from, or combined in the flow diagram without deviating from the scope of the embodiment.

At 200, host 5 transfers a request to the trusted configuration manager via communication link 96 for user bitstream (e.g., an untrusted user bitstream) load services into the partial region for a user circuit. The host and trusted configuration manager communicate over communication link 96 for these transfers.

At 205, the trusted configuration manager loads a partial bitstream for the security accelerator from the non-volatile memory 54 into the partial reconfiguration interface 70. Under control of the trusted configuration manager, the partial bitstream may be transmitted from non-volatile memory 54, across communication link 100, through the trusted configuration manager, and across communication link 90 to the partial reconfiguration interface.

The partial bitstream for the security accelerator may include the partial bitstream for one or more security processors, such as the SHA-256 processor and the ECDSA processor. The partial bitstream for the security processors is trusted because the partial bitstream is stored in, and loaded from, the non-volatile memory 54 that is located on card 35. A manufacturer of the configurable IC die, a data center provider, or other trusted user may the originator of the partial bitstream, therefore, the partial bitstream is be trusted (e.g., not corrupted by an unauthorized user).

The partial reconfiguration interface may transfer the partial bitstream to other circuits in the configurable IC die for configuring the partial region (e.g., configuring the lookup tables of the configurable IC die) with the security accelerator. The process of configuring the partial region using a partial bitstream is well understood by those of skill in the art and is not described further.

At 210, the trusted configuration manager sets one or more control bits of the multiplexer to configure the multiplexer to receive input from the security accelerator across communication link 102. The control bits may be set across communication link 94.

At 215, the host pushes the user bitstream from host memory through the trusted configuration manager to the security accelerator. Specifically, the host may transfer the user bitstream across communication link 96 to the trusted configuration manager. The trusted configuration manager may transfer the bitstream across communication link 104 to one or more security processors of the security accelerator.

At 220, the security accelerator processes the bitstream as the bitstream is transferred through the security accelerator to the local memory for storage. Specifically, as one or more of the security processors receive the user bitstream, the one or more security processors process the user bitstream according to the security functions (e.g., decryption, hash function, or other functions) that the security processors are configured to perform.

As portions of the user bitstream are processed, the security accelerator may control the transfer of the user bitstream to the local memory, across communication link 102 to the multiplexer, and through the multiplexer across communication link 98 to the local memory.

At 225, if the security accelerator determines that the user bitstream is from a trusted source (i.e., the claimed source of the user bitstream), has not be tampered with (i.e., has not been corrupted), or both, then the security accelerator may transmit an indication to the trusted configuration manager that the user bitstream is authentic. Specifically, if the one or more security processors determine that the user bitstream is authentic, then one or more of the security processors may transmit the indication to the trusted configuration manager of the authenticity.

If the security accelerator includes two or more security processors, the security processors may operate in parallel. In an embodiment, the security processors operate serially. In an embodiment, the security processors operate in serial and in parallel, for example, if the security accelerator includes three or more security processors.

If the security accelerator determines that the user bitstream is from a non-trusted source (i.e., not the claimed source of the user bitstream), has been tampered with (i.e., has been corrupted), or both, then the security accelerator may transmit an indication to the trusted configuration manager that the user bitstream has not been authenticated and is not authentic. Specifically, if the one or more security processors determine that the user bitstream is not authentic, then one or more of the security processors may transmit an indication to the trusted configuration manager of non-authenticity.

At 230, if the trusted configuration manager receives an indication from the security accelerator (i.e., security processors) that the user bitstream is authentic, then the trusted configuration manager accesses the user bitstream in the local memory, and loads the user bitstream into the partial reconfiguration interface. Specifically, the trusted configuration manager may transfer one or more control bits to the multiplexer via communication link 94 for the multiplexer to transmit the user bitstream onto communication link 94 for receipt by the trusted configuration manager. That is, the control bits may configure the multiplexer not to transmit the user bitstream into the security accelerator via communication link 102. The trusted configuration manager may transmit the user bitstream to the partial reconfiguration interface via communication link 90. Thereafter, the partial region may be configured with one or more user circuits associated with the user bitstream.

At 235, the trusted configuration manager transmits one or more indicators to the host to indicate whether the user bitstream loaded successfully or unsuccessfully into the partial reconfiguration interface. Thereafter, the host can use the one or more user circuits to service the user's data, or may request a reconfiguration of the partial region with the user bitstream.

At 240 the trusted configuration manager may indicate to one or more circuit devices (e.g., the BMC of the PCIe card) of the PCIe card or configurable IC die that the security accelerator is no longer needed and that the circuit device may allow for the security accelerator to be overwritten with a user circuit, and the trusted configuration manager may reallocate the multiplexer to the partial region via one or more control signal transmitted over communication link 94 to the multiplexer.

At 245, if the trusted configuration manager receives an indication from the security accelerator (i.e., security processors) that the user bitstream is not authentic, then the trusted configuration manager may indicate to one or more circuit devices (e.g., the BMC of the PCIe card) of the PCIe card or the configurable IC die that the security accelerator is no longer needed and that the circuit device may allow for the security accelerator to be overwritten with user design logic (i.e., a user circuit), and the trusted configuration manager may reallocate the multiplexer to the partial region via one or more control signal transmitted over communication link 94 to the multiplexer.

Providing for the security accelerator to be overwritten in the core fabric if the user bitstream is not authentic or has been used to process a user bitstream, allows for the usable resources of the partial region to be increased when a user bitstream is not authenticated. Also, the trusted configuration manager may use a security processor in the partial region as if the security processor were static, when the security processor is not static. Further, because a security processor may be overwritten, the security processor does not consume a portion of the static region of the core fabric with a security processor that is primarily idle. Providing for a security processor to be loaded into the primary region and later overwritten after use, is a tradeoff between area usage of the primary region and processing latency associated with a security processor load.

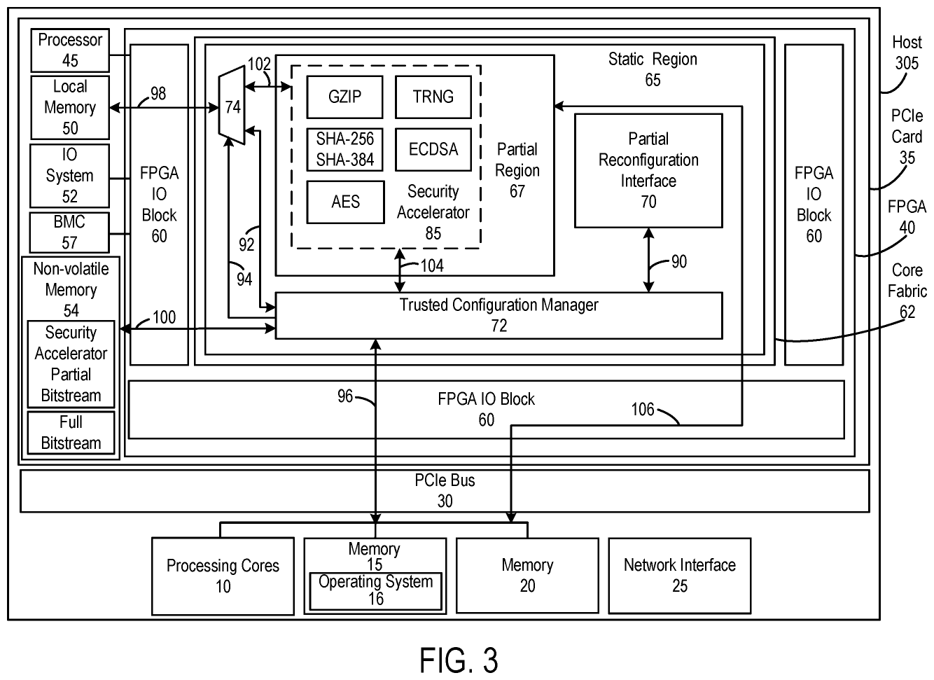

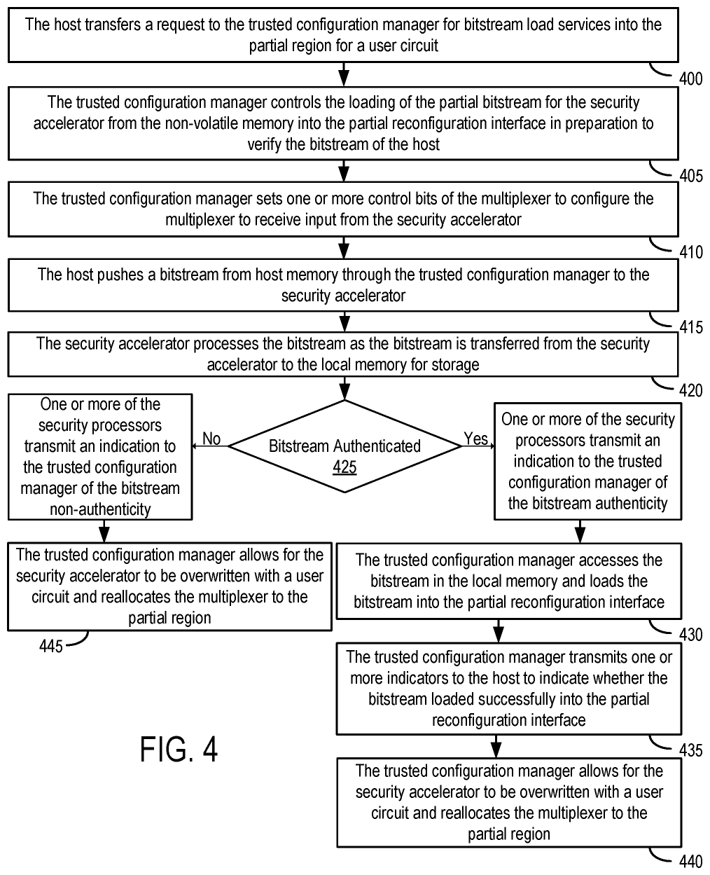

FIG. 3 illustrates a host 305 that includes a configurable IC die, such as an FPGA, in an embodiment. Host 305 is similar to host 5, but differs in that host 305 includes a communication link 106 between the host and the security accelerator. Communication link 106 passes from the host, through bus 30, through the FPGA IO block 60, and through the routing channels and switch blocks of the core fabric to the security accelerator. Communication link 106 does not pass through the trusted configuration manager. A method verifying a user bitstream as authentic or not authentic is similar to the method described above with respect to FIG. 2 but differs as described below with respect to FIG. 4.

FIG. 4 is a flow diagram of a method for authenticating a user bitstream, in an embodiment. The flow diagram represents one example embodiment. Steps may be added to, removed from, or combined in the flow diagram without deviating from the scope of the embodiment.

At 400, host 305 transfers a request to the trusted configuration manager via communication link 96 for user bitstream (e.g., an untrusted user bitstream) load services into the partial region for a user circuit. The host and trusted configuration manager communicate over communication link 96 for these transfers.

At 405, the trusted configuration manager loads a partial bitstream for the security accelerator from the non-volatile memory 54 into the partial reconfiguration interface 70. Under control of the trusted configuration manager, the partial bitstream may be transmitted from non-volatile memory 54, across communication link 100, through the trusted configuration manager, and across communication link 90 to the partial reconfiguration interface.

The partial bitstream for the security accelerator may include the partial bitstream for one or more security processors, such as the SHA-256 processor and the ECDSA processor. The partial bitstream for the security processors is trusted because the partial bitstream is stored in, and loaded from, the non-volatile memory 54 that is located on card 35. A manufacturer of the configurable IC die, a data center provider, or other trusted user may be the originator of the partial bitstream, therefore, the partial bitstream is be trusted (e.g., not corrupted by an unauthorized user).

The partial reconfiguration interface may transfer the partial bitstream to other circuits in the configurable IC die for configuring the partial region (e.g., configuring the lookup tables of the configurable IC die) with the security accelerator. The process of configuring the partial region using a partial bitstream is well understood by those of skill in the art and is not described further.

At 410, the trusted configuration manager sets (using communication link 94) one more control bits of the multiplexer to configure the multiplexer to receive input from the security accelerator across communication link 102. The control bits may be set across communication link 94.

At 415, the host pushes the user bitstream from host memory through the trusted configuration manager to the security accelerator. Specifically, the host may transfer the user bitstream across communication link 96 to the trusted configuration manager. The trusted configuration manager may transfer the bitstream across communication link 104 to one or more security processors of the security accelerator.

At 420, the security accelerator processes the bitstream as the bitstream is transferred through the security accelerator to the local memory for storage. Specifically, as one or more of the security processors receive the user bitstream, the one or more security processors process the user bitstream according to the security functions (e.g., decryption, hash function, or other functions) that the security processors are configured to perform.

As portions of the user bitstream are processed, the security accelerator may control the transfer of the user bitstream to the local memory, across communication link 102 to the multiplexer, and through the multiplexer across communication link 98 to the local memory.

At 425, if the security accelerator determines that the user bitstream is from a trusted source (i.e., the claimed source of the user bitstream), has not be tampered with (i.e., has not been corrupted), or both, then the security accelerator may transmit an indication to the trusted configuration manager that the user bitstream has been authenticated and is authentic. Specifically, if the one or more security processors determine that the user bitstream is authentic, then one or more of the security processors may transmit an indication to the trusted configuration manager of the authenticity.

If the security accelerator includes two or more security processors, the security processors may operate in parallel. In an alternative embodiment, the security processors operate in parallel. In another alternative embodiment, the security processors or may operate in serial and in parallel, for example, if the security accelerator includes three or more security processors.

If the security accelerator determines that the user bitstream is from a non-trusted source (i.e., not the claimed source of the user bitstream), has been tampered with (i.e., has been corrupted), or both, then the security accelerator may transmit an indication to the trusted configuration manager that the user bitstream has not been authenticated and is not authentic. Specifically, if the one or more security processors determine that the user bitstream is not authentic, then one or more of the security processors may transmit an indication to the trusted configuration manager of non-authenticity.

At 430, if the trusted configuration manager receives an indication from the security accelerator (i.e., security processors) that the user bitstream is authentic, then the trusted configuration manager accesses the user bitstream in the local memory, and loads the user bitstream into the partial reconfiguration interface. Specifically, the trusted configuration manager may transfer one or more control bits to the multiplexer via communication link 94 for the multiplexer to transmit the user bitstream onto communication link 94 for receipt by the trusted configuration manager. That is, the control bits may configure the multiplexer not to transmit the user bitstream into the security accelerator via communication link 102. The trusted configuration manager may transmit the user bitstream to the partial reconfiguration interface via communication link 90. Thereafter, the partial region may be configured with one or more user circuits associated with the user bitstream.

At 435, the trusted configuration manager transmits one or more indicators to the host to indicate whether the user bitstream loaded successfully or unsuccessfully into the partial reconfiguration interface. Thereafter, the host can use the one or more user circuits to service the user's data, or may request a reconfiguration of the partial region with the user bitstream.

At 440 the trusted configuration manager may indicate to one or more circuit devices (e.g., the BMC of the PCIe card) of the PCIe card or configurable IC die that the security accelerator is no longer needed and that the circuit device may allow for the security accelerator to be overwritten with a user circuit, and the trusted configuration manager may reallocate the multiplexer to the partial region via one or more control signal transmitted over communication link 94 to the multiplexer.

In an embodiment, the communication link 106 may also be allowed to be overwritten after the security processor is used to authenticate the user bitstream. The communication link may be allowed to be overwritten as described above to the one or more security processors of the security accelerator at 440.

At 445, if the trusted configuration manager receives an indication from the security accelerator (i.e., security processors) that the user bitstream is not authentic, then the trusted configuration manager may indicate to one or more circuit devices (e.g., the BMC of the PCIe card) of the PCIe card or the configurable IC die that the security accelerator is no longer needed and that the circuit device may allow for the security accelerator to be overwritten with user design logic (i.e., a user circuit), and the trusted configuration manager may reallocate the multiplexer to the partial region via one or more control signal transmitted over communication link 94 to the multiplexer.

In an embodiment, the communication link 106 may also be allowed to be overwritten if the user bitstream if not authentic. The communication link may be allowed to be overwritten as described above to the one or more security processors of the security accelerator at 435.

In an embodiment, at either 230 or 430, the full bitstream in non-volatile memory 54 for the partial region 67 may be loaded into the partial reconfiguration interface and the partial region may be configured with the full bitstreams. The full bitstreams are the bitstreams for all of the circuits configured into the partial region including the bitstream from the local memory. In an embodiment, the full bitstream does not include the security accelerator partial bitstream for the security accelerator. In some embodiments, configuring the partial region with the full bitstreams may be a faster process than partially reconfiguring the partial region with bitstream stored in local memory.

In an embodiment, other bitstreams may be verified as authentic or non-authentic using the methods described above. For example, any bitstream that is to be loaded into non-volatile memory 54 may be verified as authentic or non-authentic before the bitstream is allowed by loaded into the partial reconfiguration interface or another interface that is used to configure the partial region of the core fabric. The bitstreams may be for any manufacturer circuits, host circuits, or user circuits that are to be configured into the partial region.

In an embodiment, other bitstreams may be verified as authentic or non-authentic using the methods described above. For example, firmware for various circuits of the PCIe card may be verified as authentic or non-authentic, such as the firmware for the BMC of the PCIe card. For example, a bitstream for BMC 57 may be loaded into the local memory 57 as described above, verified as authentic or non-authentic using the security accelerator, and if authentic, the trusted configuration manager may route the bitstream from the local memory (configure the mux) into the non-volatile memory if the firmware for the BMC is stored in non-volatile memory or into other memory used for storing the firmware for the BMC.

Also, the firmware that is to be installed on one or more circuits on the PCIe card may be verified as authentic or non-authentic. The bitstreams for these firmware may be loaded onto the configurable IC die for authentication or non-authentication as described above with respect to FIGS. 2 and 4, and then the bitstreams may be transferred from the configurable IC die to circuits on the PCIe card for storage and use if the bitstreams are authenticated. For example, the firmware for the network interface ASIC on the PCIe card may be verified as authentic or non-authentic as described above, and loaded onto the network interface ASIC if authentic.

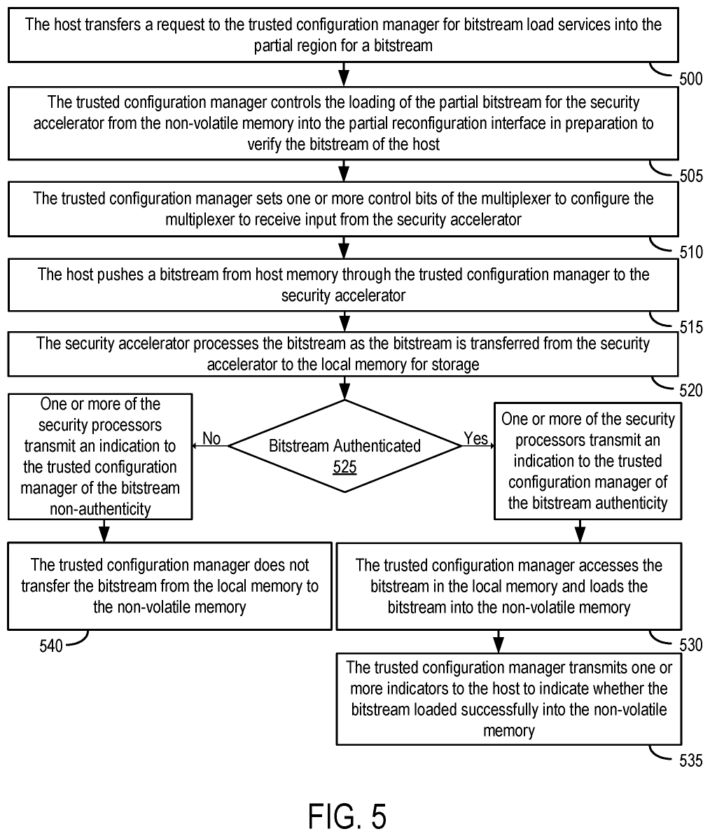

FIG. 5 is a flow diagram of a method for authenticating a bitstream where the destination for the bitstream is the non-volatile memory, in an embodiment. The bitstream may be the full bitstream for the core fabric or may be for a firmware update. The flow diagram represents one example embodiment. Steps may be added to, removed from, or combined in the flow diagram without deviating from the scope of the embodiment.

At 500, host 5 transfers a request to the trusted configuration manager via communication link 96 for bitstream load services into the partial region. The host and trusted configuration manager communicate over communication link 96 for these transfers.

At 505, the trusted configuration manager loads a partial bitstream for the security accelerator from the non-volatile memory 54 into the partial reconfiguration interface 70. Under control of the trusted configuration manager, the partial bitstream may be transmitted from non-volatile memory 54, across communication link 100, through the trusted configuration manager, and across communication link 90 to the partial reconfiguration interface.

The partial bitstream for the security accelerator may include the partial bitstream for one or more security processors, such as the SHA-256 processor and the ECDSA processor. The partial bitstream for the security processors is trusted because the partial bitstream is stored in, and loaded from, the non-volatile memory 54 that is located on card 35. A manufacturer of the configurable IC die, a data center provider, or other trusted user may be the originator of the partial bitstream, therefore, the partial bitstream is be trusted (e.g., not corrupted by an unauthorized user).

The partial reconfiguration interface may transfer the partial bitstream to other circuits in the configurable IC die for configuring the partial region (e.g., configuring the lookup tables of the configurable IC die) with the security accelerator. The process of configuring the partial region using a partial bitstream is well understood by those of skill in the art and is not described further.

At 510, the trusted configuration manager sets (using communication link 94) one more control bits of the multiplexer to configure the multiplexer to receive input from the security accelerator across communication link 102.

At 515, the host pushes the bitstream from host memory through the trusted configuration manager to the security accelerator. Specifically, the host may transfer the bitstream across communication link 96 to the trusted configuration manager. The trusted configuration manager may transfer the bitstream across communication link 104 to one or more security processors of the security accelerator. Alternatively, the host may push the bitstream to one or more security processors of the security accelerator without the bitstream passing through the trusted configuration manager.

At 520, the security accelerator processes the bitstream as the bitstream is transferred through the security accelerator to the local memory for storage. Specifically, as one or more of the security processors receive the bitstream, the one or more security processors process the bitstream according to the security functions (e.g., decryption, hash function, or other functions) that the security processors are configured to perform.

As portions of the bitstream are processed, the security accelerator may control the transfer of the bitstream to the local memory, across communication link 102 to the multiplexer, and through the multiplexer across communication link 98 to the local memory.

At 525, if the security accelerator determines that the bitstream is from a trusted source (i.e., the claimed source of the bitstream), has not be tampered with (i.e., has not been corrupted), or both, then the security accelerator may transmit an indication to the trusted configuration manager that the bitstream is authentic. Specifically, if the one or more security processors determine that the bitstream is authentic, then one or more of the security processors may transmit the indication to the trusted configuration manager of the authenticity.

If the security accelerator determines that the bitstream is from a non-trusted source (i.e., not the claimed source of the bitstream), has been tampered with (i.e., has been corrupted), or both, then the security accelerator may transmit an indication to the trusted configuration manager that the bitstream has not been authenticated and is not authentic. Specifically, if the one or more security processors determine that the bitstream is not authentic, then one or more of the security processors may transmit an indication to the trusted configuration manager of non-authenticity.

At 530, if the trusted configuration manager receives an indication from the security accelerator (i.e., security processors) that the bitstream is authentic, then the trusted configuration manager accesses the bitstream in the local memory, and loads the bitstream into the non-volatile memory from the local memory. Specifically, the trusted configuration manager may set one or more control bits to the multiplexer via communication link 94 for the multiplexer to transmit the bitstream onto communication link 94 for receipt by the trusted configuration manager. That is, the control bits may configure the multiplexer not to transmit the bitstream into the security accelerator via communication link 102. The trusted configuration manager may transmit the bitstream to the non-volatile memory via communication link 100. Thereafter, the partial region may be configured with the bitstream by the trusted configuration manager transferring the bitstream to the partial reconfiguration interface.

At 535, the trusted configuration manager transmits one or more indicators to the host to indicate whether the bitstream loaded successfully or unsuccessfully into the non-volatile memory.

At 540, if the trusted configuration manager receives an indication from the security accelerator (i.e., security processors) that the bitstream is not authentic, then the trusted configuration manager may not transfer the bitstream from the local memory to the non-volatile memory.

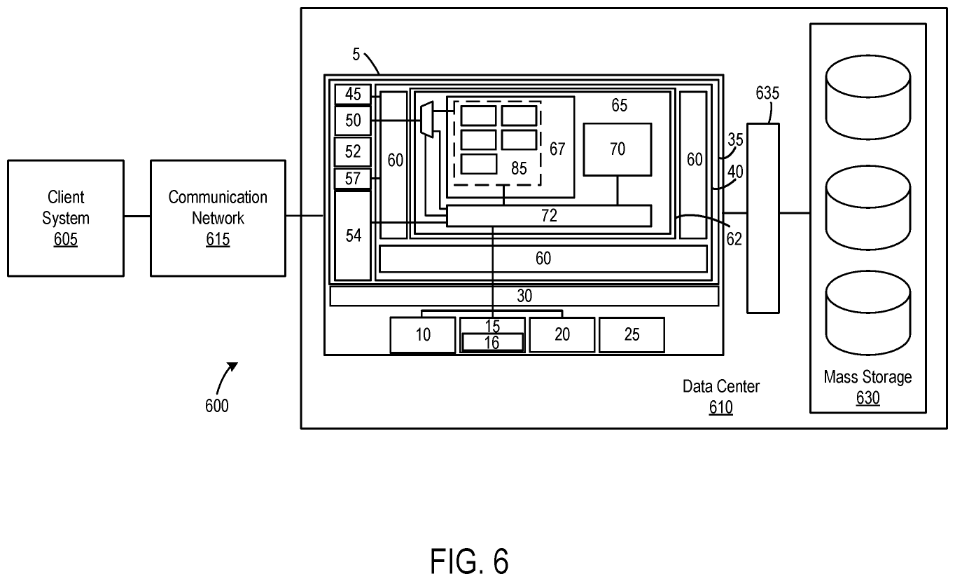

FIG. 6 illustrates a data system 600, in an embodiment. Data system 600 includes a client system 605 that is adapted to access a data center 610 using a communication network 615. The client system 605 may include one or more client computers that are adapted to access data stored in the data center. The client computer may include a server, a desktop computer, a laptop computer, a mobile device (e.g., a tablet computer, a smartphone, or other devices), any combination of these devices, or other devices. The client computer may transfer data to the data center for storage in the data center, retrieve data from the data center, or request the alteration of data in the data center. Communication network 615 may include one or more networks, such as the Internet, one or more intranets, or other network systems.

Data center 610 includes a host 5 or 305 (i.e., server), mass storage 630, an IP switch 635, and may include other elements. The host in the data center may include one or more cards 35, any of the configurable IC dies 40 described above and shown in the figures, and other circuits described above. Host 5 or 305, card 35, and configurable IC die 40 in the data center may operate according to any of the methods described and illustrated, such as the methods illustrated in FIGS. 2 and 4

Mass storage 630 includes one or more types of memory devices, such as a disk array that includes several disk memory devices (e.g., magnetic disk memory), optical storage (e.g., optical disk storage), solid-state memory, tape memory, and others. The memory devices may be located in one or more data center racks, which include one or more of the servers, the IP switch, both, or do not include the servers and the IP switch. The IP switch routes communication packets between the servers and the memory devices of the mass storage.

The one or more processing cores 10 of the server may communicate with the configurable IC die 35 at a single data rate (SDR), double data rate (DDR), or quad data rate (QDR) in half or full duplex mode. The memory subsystem may include DDR non-volatile memory, 3D xPoint non-volatile memory, or other types of memory.

The server may be an aggregated server or a disaggregated server. Various component of the server may be located on a single sled in a data center rack, are distributed among two or more sleds in a data center rack, or are distributed among a number of sleds in a number of data center racks. Distributing components of a server among sleds, data center racks, or both may facilitate relatively fast communication between the components by positioning select components in frequent communication relatively close to each other. For example, in a server where the processor accesses the memory subsystem more frequently than the configurable IC die (e.g., FPGA), the processor and memory subsystem may be located relatively close (e.g., on a first sled) in a data center rack and the configurable IC die may be located farther from the memory subsystem (e.g., on a different second sled) in the data center rack. Alternatively, the second sled may be positioned nearer the mass storage than the first sled, for example, if the configurable IC die accesses the mass storage with a higher frequency than the processor.

In an embodiment, a bitstream for a user circuit is transmitted from client system 605 to the host in the data center where the bitstream is authenticated or not authenticated as described above. The bitstream may be transmitted across the communication network to the datacenter. A client system may transmit a bitstream for a user circuit before the client system will use the user circuit for processing user data in the data center. The user data may be transmitted to the data center and configurable IC die for processing by the user circuit after the user circuit is configured into the partial region of the core fabric of the configurable IC die.

In an embodiment, a number of client systems are connected to the data center by the communication network and each client system may transmit various bitstreams for various user circuits that are to be configured into the partial region of the configurable IC die. Each client systems may transmit a bitstream for a user circuit when the client systems will use the user circuits for processing user data in the data center. The user data may be transmitted to the data center and configurable IC die for processing by the user circuits after the user circuits are configured into the partial region of the core fabric of the configurable IC die.

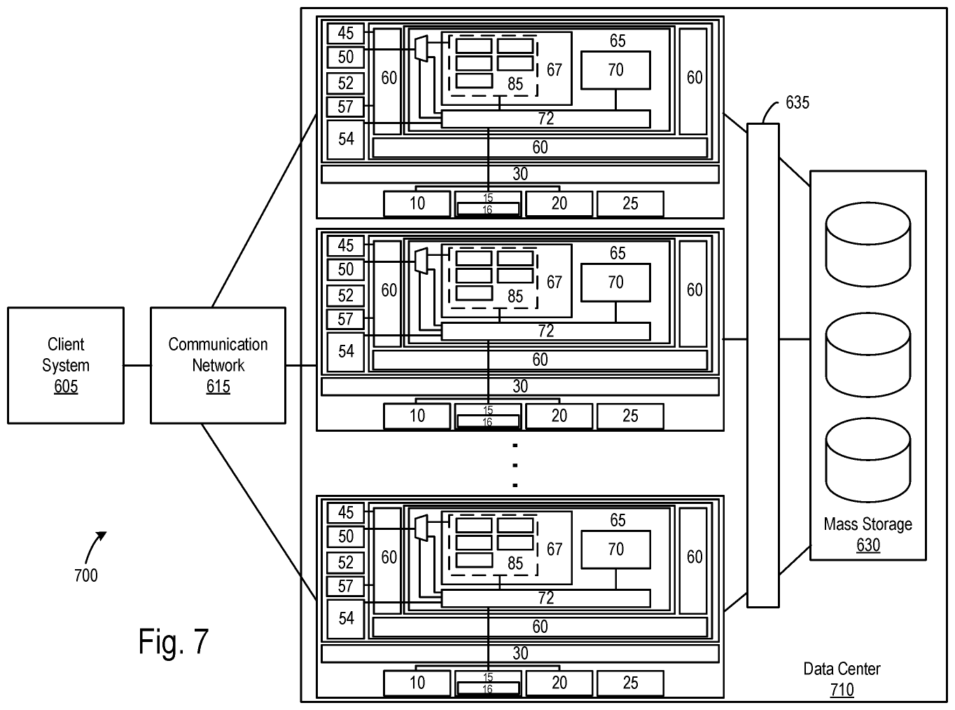

FIG. 7 illustrates a data system 700, in an embodiment. Data system 700 is similar to data center 700, but includes a data center 710 that includes a number of hosts 5 (i.e., servers). Further, each of the hosts in the data center may include any of the cards 35 and any of the configurable IC dies 40 described above and shown in the figures.

This description has been presented for the purposes of illustration and description. It is not intended to be exhaustive or to limit the invention to the precise form described, and many modifications and variations are possible in light of the teaching above. For example, while SiP devices have been described above, embodiments described may be applied to a variety of multi-chip modules, multi-die assemblies, system-on-package devices, and other multi-die devices. The embodiments were chosen and described in order to best explain the principles of the embodiments and their practical applications. This description will enable others skilled in the art to best utilize and practice the invention in various embodiments and with various modifications as are suited to a particular use. The scope of the invention is defined by the following claims.

### EXAMPLES

The following examples pertain to further embodiments.

Example 1 is a method including: receiving, from a host, by a trusted configuration manager circuit of a configurable integrated circuit (IC), a request for bitstream load services of a bitstream for a user circuit into a partial region of a core fabric of the configurable IC die; loading, by the trusted configuration manager circuit, from a non-volatile memory of the host, a security processor into the partial region of the core fabric of the configurable IC die circuit; loading, from the host, through the trusted configuration manager, to the security processor, the bitstream; processing the bitstream, by the security processor, to determine if the bitstream is authentic or not authentic; transferring the bitstream from the security processor to a local memory as the security processor is processing the bitstream; transmitting an indication to the trusted configuration manager that the bitstream is not authentic if the security processor determines that the bitstream not authentic and allowing for the security processor to be overwritten based on the non-authenticity of the bitstream; and transmitting an indication to the trusted configuration manager that the bitstream is authentic if the security processor determines that the bitstream authentic and transferring the bitstream by the trusted configuration manager from the local memory into a partial reconfiguration interface for configuring the partial region of the core fabric with the bitstream.

Example 2 is a method of example 1, wherein the local memory is a double data rate RAM that is accessible by the configurable IC die.

Example 3 is a method of example 2, wherein the local memory is not accessible by other circuits of the host.

Example 4 is a method of example 1, wherein the configurable IC die is on a PCIe card in the host.

Example 5 is a method of example 1, wherein method includes configuring the partial region of the core fabric with the bitstream in the partial reconfiguration interface circuit if the bitstream is authentic.

Example 6 is a method of example 1, wherein the method includes transmitting an indicator from the trusted configuration manager to a baseboard management controller for allowing the security processor to be overwritten if the bitstream is not authentic.

Example 7 is a method of example 6, wherein the method includes allowing by the baseboard management controller the security processor to be overwritten.

Example 8 is a method of example 6, wherein the method includes configuring, by the trusted configuration manager, a multiplexer to route the bitstream from the security processor to the local memory.

Example 9 is a method of example 8, wherein the method includes configuring, by the trusted configuration manager, the multiplexer to route the bitstream from the local memory through the trusted configuration manager to the partial reconfiguration interface.

Example 10 is a method of example 9, wherein the method includes configuring, by the trusted configuration manager, the multiplexer to route the bitstream from the local memory through the trusted configuration manager to the partial reconfiguration interface without transmitting the bitstream through the security processor.

Example 11 is a method of example 9, wherein the method includes configuring, by the trusted configuration manager, the multiplexer to communicate with the security processor after the multiplexer routes the bitstream from the local memory through the trusted configuration manager to the partial reconfiguration interface.

Example 12 is a method of example 1, wherein the method includes allowing, by the trusted configuration manager, for the security processor to be overwritten after the bitstream is transferred into a partial reconfiguration interface.

Example 13 is a method comprising: receiving, from a host at a trusted configuration manager circuit of a configurable integrated circuit (IC), a request for bitstream load services of a bitstream for a user circuit into a partial region of a core fabric of the configurable IC die; loading, by the trusted configuration manager circuit, from a non-volatile memory of the host, a security processor into the partial region of the core fabric of the configurable IC die circuit; loading, from the host to the security processor, the bitstream; processing the bitstream, by the security processor, to determine if the bitstream is authentic or not authentic; transferring the bitstream from the security processor to a local memory as the security processor is processing the bitstream; transmitting an indication to the trusted configuration manager that the bitstream is not authentic if the security processor determines that the bitstream not authentic and allowing for the security processor to be overwritten based on the non-authenticity of the bitstream; and transmitting an indication to the trusted configuration manager that the bitstream is authentic if the security processor determines that the bitstream authentic and transferring the bitstream by the trusted configuration manager from the local memory into a non-volatile memory for configuring the partial region of the core fabric with the bitstream.

Example 14 is the method of claim 13, wherein loading, from the host to the security processor, the bitstream comprises not routing the bitstream into the security processor through the trusted configuration manager.

Example 15 is the method of claim 13, wherein the static region of the core fabric includes a communication link between an input-output block of the configurable IC die and the security processor.

Example 16 is the method of claim 13, further comprising, configuring a communication link into the core fabric between an input-output block of the configurable IC die and the security processor.

Example 17 is the method of claim 13, wherein configuring the communication link into the core fabric between the input-output block of the configurable IC die and the security processor comprises configuring the communication link into the core fabric after the security processor is loaded into the partial region of the core fabric of the configurable IC die circuit.

Example 18 is a system comprising: a configurable integrated circuit die comprising an input-output (IO) block and a core fabric coupled to the IO block, wherein the core fabric comprises a partial region configurable with user circuits and a security processor, and comprises a static region, which comprises a trusted configuration manager circuit, a partial reconfiguration interface circuit coupled to the trusted configuration manager circuit, and a multiplexer coupled to the trusted configuration manager by a first communication link and to a security processor by a second communication link when the security processor is in the partial region; local memory coupled to the multiplexer by a third communication link, wherein the trusted configuration manager circuit and the security processor are muliplexable by the multiplexer to the local memory when the security processor is configured into the partial region, and the trusted configuration manager is coupled to control input of the multiplexer by a fourth communication link to control multiplexing by the multiplexer; a non-volatile memory coupled to the trusted configuration manager by a fifth communication link and storing first data for a security processor, wherein the first data configured into the partial region is the security processor; and a host system comprising a memory, wherein the memory is coupled to the trusted configuration manager circuit by a sixth communication link, the memory stores second data for a user circuit, and the second data configured into the partial region is the user circuit, wherein the security processor is adapted to authentic the second data when the second data is loaded from the memory of the host, through the trusted configuration manager, through the security processor, and through the multiplexer to the local memory.

Example 19 is the method of claim 18, further comprising a PCIe card, wherein the configurable IC die, the local memory, and the non-volatile memory are mounted on the PCIe card, and the PCIe card is coupled to the host system by a PCIe slot.

Example 20 is the method of claim 18, wherein the memory of the host is coupled to the security processor by a seventh communication link that is at least partially configured into the core fabric when the security processor is configured into the partial region, and the seventh communication link is not a communication link for the trusted configuration manager.

The invention claimed is:

1. A method comprising:
receiving, from a host, by a trusted configuration manager circuit of a configurable integrated circuit (IC), a request for bitstream load services of a bitstream for a user circuit into a partial region of a core fabric of the configurable IC die;
loading, by the trusted configuration manager circuit, from a non-volatile memory of the host, a security processor into the partial region of the core fabric of the configurable IC die circuit;
loading, from the host, through the trusted configuration manager, to the security processor, the bitstream;
processing the bitstream, by the security processor, to determine if the bitstream is authentic or not authentic;
transferring the bitstream from the security processor to a local memory as the security processor is processing the bitstream;
transmitting an indication to the trusted configuration manager that the bitstream is not authentic if the security processor determines that the bitstream not authentic and allowing for the security processor to be overwritten based on the non-authenticity of the bitstream; and
transmitting an indication to the trusted configuration manager that the bitstream is authentic if the security processor determines that the bitstream authentic and transferring the bitstream by the trusted configuration manager from the local memory into a partial reconfiguration interface for configuring the partial region of the core fabric with the bitstream.

2. The method of claim 1, wherein the local memory is a double data rate RAM that is accessible by the configurable IC die.

3. The method of claim 2, wherein the local memory is not accessible by other circuits of the host.

4. The method of claim 1, wherein the configurable IC die is on a PCIe card in the host.

5. The method of claim 1, further comprising configuring the partial region of the core fabric with the bitstream in the partial reconfiguration interface circuit if the bitstream is authentic.

6. The method of claim 1, further comprising transmitting an indicator from the trusted configuration manager to a baseboard management controller for allowing the security processor to be overwritten if the bitstream is not authentic.

7. The method of claim 6, further comprising allowing by the baseboard management controller the security processor to be overwritten.

8. The method of claim 6, further comprising configuring, by the trusted configuration manager, a multiplexer to route the bitstream from the security processor to the local memory.

9. The method of claim 8, further comprising configuring, by the trusted configuration manager, the multiplexer to route the bitstream from the local memory through the trusted configuration manager to the partial reconfiguration interface.

10. The method of claim 9, further comprising configuring, by the trusted configuration manager, the multiplexer to route the bitstream from the local memory through the trusted configuration manager to the partial reconfiguration interface without transmitting the bitstream through the security processor.

11. The method of claim 9, further comprising configuring, by the trusted configuration manager, the multiplexer to communicate with the security processor after the multiplexer routes the bitstream from the local memory through the trusted configuration manager to the partial reconfiguration interface.

12. The method of claim 1, further comprising allowing, by the trusted configuration manager, for the security processor to be overwritten after the bitstream is transferred into a partial reconfiguration interface.

13. A method comprising:
receiving, from a host, by a trusted configuration manager circuit of a configurable integrated circuit (IC), a request for bitstream load services of a bitstream for a user circuit into a partial region of a core fabric of the configurable IC die;
loading, by the trusted configuration manager circuit, from a non-volatile memory of the host, a security processor into the partial region of the core fabric of the configurable IC die circuit;
loading, from the host to the security processor, the bitstream;
processing the bitstream, by the security processor, to determine if the bitstream is authentic or not authentic;
transferring the bitstream from the security processor to a local memory as the security processor is processing the bitstream;
transmitting an indication to the trusted configuration manager that the bitstream is not authentic if the security processor determines that the bitstream not authentic and allowing for the security processor to be overwritten based on the non-authenticity of the bitstream; and
transmitting an indication to the trusted configuration manager that the bitstream is authentic if the security processor determines that the bitstream authentic and transferring the bitstream by the trusted configuration manager from the local memory into a non-volatile memory for configuring the partial region of the core fabric with the bitstream.

14. The method of claim 13, wherein loading, from the host to the security processor, the bitstream comprises not routing the bitstream into the security processor through the trusted configuration manager.

15. The method of claim 13, wherein the static region of the core fabric includes a communication link between an input-output block of the configurable IC die and the security processor.

16. The method of claim 13, further comprising, configuring a communication link into the core fabric between an input-output block of the configurable IC die and the security processor.

17. The method of claim 16, wherein configuring the communication link into the core fabric between the input-output block of the configurable IC die and the security processor comprises configuring the communication link into the core fabric after the security processor is loaded into the partial region of the core fabric of the configurable IC die circuit.

18. A system comprising:
a configurable integrated circuit die comprising an input-output (IO) block and a core fabric coupled to the IO block, wherein the core fabric comprises a partial region configurable with user circuits and a security processor, and comprises a static region, which comprises a trusted configuration manager circuit, a partial reconfiguration interface circuit coupled to the trusted configuration manager circuit, and a multiplexer coupled to the trusted configuration manager by a first communication link and to a security processor by a second communication link when the security processor is in the partial region;
local memory coupled to the multiplexer by a third communication link, wherein the trusted configuration manager circuit and the security processor are muliplexable by the multiplexer to the local memory when the security processor is configured into the partial region, and the trusted configuration manager is coupled to control input of the multiplexer by a fourth communication link to control multiplexing by the multiplexer;
a non-volatile memory coupled to the trusted configuration manager by a fifth communication link and storing first data for a security processor, wherein the first data configured into the partial region is the security processor; and
a host system comprising a memory, wherein the memory is coupled to the trusted configuration manager circuit by a sixth communication link, the memory stores second data for a user circuit, and the second data configured into the partial region is the user circuit, wherein the security processor is adapted to authentic the second data when the second data is loaded from the memory of the host, through the trusted configuration manager, through the security processor, and through the multiplexer to the local memory.

19. The system of claim 18, further comprising a PCIe card, wherein the configurable IC die, the local memory, and the non-volatile memory are mounted on the PCIe card, and the PCIe card is coupled to the host system by a PCIe slot.

20. The system of claim 18, wherein the memory of the host is coupled to the security processor by a seventh communication link that is at least partially configured into the core fabric when the security processor is configured into the partial region, and the seventh communication link is not a communication link for the trusted configuration manager.
